(19) United States
(12) Patent Application Publication
(10) Pub. No.: US 2021/0070014 A1
(43) Pub. Date: Mar. 11, 2021

(54) Light transmissive, user-interactive polymeric film

(71) Applicant: CANADIAN GENERAL-TOWER LIMITED, Cambridge (CA)

(72) Inventors: Xiaoling SUN, Cambridge (CA); Mark LOMAS, Cambridge (CA)

(73) Assignee: CANADIAN GENERAL-TOWER LIMITED, Cambridge, ON (CA)

(21) Appl. No.: 16/771,942

(22) PCT Filed: Dec. 11, 2018
(86) PCT No.: PCT/CA2018/051579

§ 371 Date: Jun. 11, 2020

Related U.S. Application Data
(60) Provisional application No. 62/597,121, filed on Dec. 11, 2017.

(51) Int. Cl. B32B 7/023; B32B 27/08; B32B 27/12; B32B 5/24; G02B 1/10; B32B 27/36; B32B 27/30; B32B 5/02; B32B 7/12; B32B 27/40; B32B 27/32

(52) U.S. Cl. CPC B32B 7/023; B32B 2307/412; B32B 27/12; B32B 5/245; G02B 1/10; B32B 27/36; B32B 27/304; B32B 5/026; B32B 7/12; B32B 27/40; B32B 27/32; B32B 2250/24; B32B 2307/4023; B32B 2307/41; B32B 2250/05; B32B 2307/738; B32B 2307/7265; B32B 2367/00; B32B 2375/00; B32B 2323/00; B32B 2327/06; B32B 2439/02; B32B 2266/0235; B32B 27/08

(57) ABSTRACT

A surface covered with a non-transparent light transmissive opaque membrane having an A side facing the surface and a B side facing an open environment. The membrane comprises a top cross-linked polyurethane layer, a foamed polyvinyl chloride (PVC) layer, a polyethylene terephthalate (PET) knit fabric layer. A light source and an input means for controlling the light source are disposed between the surface and the membrane. The input means comprising touch sensor switch or capacitive sensor is capable of being operated by touching the B side of the membrane to turn the light source on and off such that the light transmits through the membrane and can be viewed from the open environment.

### FIELD OF THE INVENTION

The present invention relates to devices or products coated with a light transmissive, user-interactive polymeric film that hides light source until use.

### BACKGROUND OF THE INVENTION

Many appliances, products and structures in use today have interfaces that allow consumers to input actions or information. Unfortunately, the nature of the interface also detracts from the aesthetics of the appliance, product or structures because the interface does not match the design of the rest of the appliance, product or structure, which is usually of a particular color, texture, or pattern. The nature of traditional input devices often includes tradition switches, buttons, toggles, and other input moving devices with moving parts.

Thus, it is desirable to provide a product (including appliances and structures such as swimming pools) with hidden capacitive or resistive switch or sensor that will allow consumers to turn on/off function(s) on the product without detracting from the overall appearance of the product. A further benefit to a weight reduction though the elimination of physical moving switches.

### SUMMARY OF THE INVENTION

In one embodiment, the present invention is a non-transparent light transmissive opaque membrane for covering the surface of a product, the membrane comprising: (a) a polyethylene terephthalate (PET) knit fabric layer for covering the surface of the product; (b) a foamed polyvinyl chloride (PVC) layer having a side attached to the PET knit fabric layer with a PVC adhesive; (c) a top crosslinked polyurethane layer; and (d) a transparent PVC layer between the top layer and the foamed layer, the transparent PVC layer having at least one side covered with a PVC based ink.

In another embodiment, the present invention is a product comprising: (a) surface, the surface being covered with a non-transparent light transmissive opaque membrane, the non-transparent light transmissive opaque membrane having an A side facing the surface, and a B exposed side, (b) a light source and an input means for controlling the light source, the light source and the input means being disposed between the surface and the A side of the membrane, said input means being capable of being operated by touch on the B side of the non-transparent light transmissive opaque membrane to turn the light source on and off, wherein said non-transparent light transmissive opaque membrane is configured to transmit light emitted from the light source from the A side to the B side such that the light can be viewed from the B exposed side.

In one embodiment of the product of the present invention, the non-transparent light transmissive opaque membrane is the membrane of according to one embodiment of the present invention, such as, for example, the membrane described in FIG. 1.

In another embodiment of the product of the present invention, the product is a consumer product.

In another embodiment of the product of the present invention, the product is an appliance, a door, a wall, a deck, a roof, a floor, a surface of an automobile, or a hand-held device.

In another embodiment of the product of the present invention, the product is a swimming pool and the non-transparent light transmissive opaque membrane is the pool liner.

In another embodiment of the product of the present invention, the input means is a pressure or touch sensor switch or a capacitive sensor.

In another embodiment of the product of the present invention, the non-transparent light transmissive opaque membrane is made of a polymer selected from thermoplastic olefin (TPO), polyvinyl chloride (PVC), polyurethane (PU), or thermoplastic polyurethane (TPU).

In one embodiment, the present invention provides for a surface coated or covered with a non-transparent light transmissive membrane, the non-transparent light transmissive membrane having an A side facing the surface, and a B side facing an open environment, a light source and an input means for controlling the light source being disposed between the surface and the A side of the membrane, said input means capable of being operated by touch on the B side of the non-transparent light transmissive membrane to turn the light source on and off, and said non-transparent light transmissive membrane being capable of transmitting light emitted from the light source from the A side to the B side such that the light can be viewed from the open environment.

In one embodiment of the coated surface of the present invention, the non-transparent light transmissive opaque membrane is the membrane of according to one embodiment of the present invention, such as, for example, the membrane described in FIG. 1.

In one embodiment of the coated surface of the present invention, the surface is part of a consumer product.

In another embodiment of the coated surface of the present invention, the surface is part of an appliance, a door, a wall, a deck, a roof, a floor, a surface of an automobile, a hand-held device.

In another embodiment of the coated surface of the present invention, the surface is the walls of a swimming pool and the non-transparent light transmissive membrane is the pool liner.

In another embodiment of the coated surface of the present invention, the input means is a pressure or touch sensor switch or a capacitive sensor.

In another embodiment of the coated surface of the present invention, the non-transparent light transmissive membrane is made of a polymer selected from thermoplastic olefin (TPO), polyvinyl chloride (PVC), polyurethane (PU), or thermoplastic polyurethane (TPU).

In one embodiment the present invention is a method of using a non-transparent, light transmissive membrane to convey information, be part of a user interface to control a device, or provide decorative or functional lighting. The method, in one embodiment, comprises (a) covering a surface having a light source with the non-transparent light transmissive membrane such that the light source is hidden by the membrane, the light source capable of emitting light, (b) turning the light source on such that the light passes through the membrane, wherein the light that passes through the membrane carries information, is part of a user interface to control a device, provide decorative lighting or functional lighting across the membrane.

### BRIEF DESCRIPTION OF THE DRAWINGS

The following figures illustrate various aspects and preferred and alternative embodiments of the invention.

FIG. 1: cross sectional view of a membrane according to one embodiment of the present invention.

FIG. 2: photograph of a light transmissive not transparent material.

FIG. 3: photograph of the light transmissive not transparent material of FIG. 2 with light passing through the non-transparent material in accordance to one aspect of the present invention.

FIG. 4: photograph of a light transmissive non-transparent material with light passing through the non-transparent material in accordance to one aspect of the present invention.

FIG. 5: photograph of a light transmissive non-transparent material with light passing through the non-transparent material in accordance to one aspect of the present invention.

FIG. 6: photograph of a light transmissive non-transparent material with light passing through the non-transparent material in accordance to one aspect of the present invention.

FIG. 7: photograph of a light transmissive non-transparent material disposed on a surface of an appliance with light passing through the non-transparent material in accordance to one aspect of the present invention.

FIG. 8: photograph of the interior surface of an automobile.

### DESCRIPTION OF THE INVENTION

### Definitions

Unless defined otherwise, all technical and scientific terms used herein have the same meaning as commonly understood by one of ordinary skill in the art to which this invention belongs. Also, unless indicated otherwise, except within the claims, the use of “or” includes “and” and vice versa. Non-limiting terms are not to be construed as limiting unless expressly stated or the context clearly indicates otherwise (for example “including”, “having” and “comprising” typically indicate “including without limitation”). Singular forms including in the claims such as “a”, “an” and “the” include the plural reference unless expressly stated otherwise. In order to aid in the understanding and preparation of the within invention, the following illustrative, non-limiting, examples are provided.

“Opaque” means not able to be seen through, not transparent or non-transparent. In this document, a membrane may be opaque in the sense that it is not transparent, and yet light transmissive.

### List of Abbreviations

TPO: thermoplastic olefin; PVC: polyvinyl chloride; PU: polyurethane; TPU: thermoplastic polyurethane; PET: Polyethylene terephthalate.

Overview

The present invention relates to a surface of a product coated with a non-transparent, light transmissive opaque membrane. The light transmissive opaque membrane is a polymeric film that hides light sources until lit. The invention functions to provide information and feedback to a user and such as lighting, signage, warnings, advertising, etc. The polymeric film functions as part of a touch-free control surface or as part of a touch switch which acts as an input to enable light source. The product can be an appliance, a door, a wall, a deck, a roof, a floor, an interior or exterior surface of an automobile, the walls of a swimming pool, or a hand-held device, and so forth.

The light-translucent membranes of the present invention are designed to allow for back-illumination of products, such as appliances, automotive interior/exterior surfaces, but maintain standard leatherette appearance when not lit. This added back-lighting functionality facilitates more streamline interior spaces free of added design features for buttons or signals. Product back-lighting is able to convey information to users, including occupants of a vehicle, through hidden light sources and to receive user inputs through embedded sensors beneath the surface. Degree of translucency can be tuned for application-specific requirements.

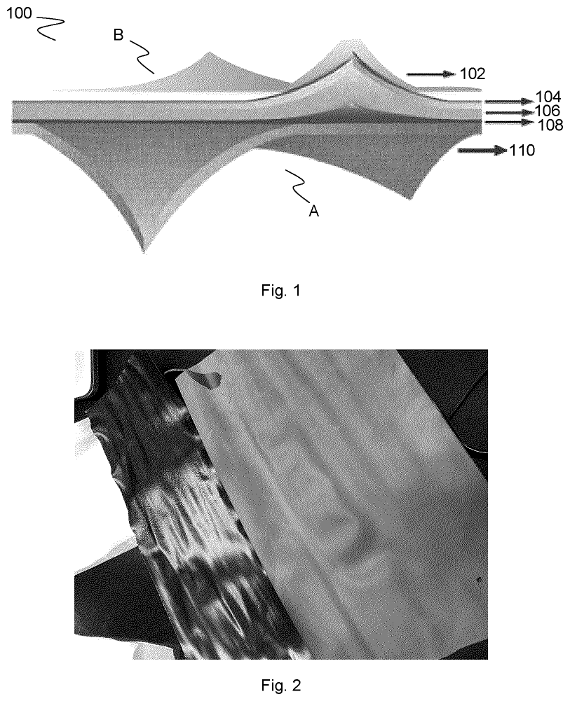

With reference to FIG. 1, the light transmissive, opaque membrane 100 of the present invention has an A side, which is the side in contact with the surface being covered, and a B side, which is the side of the membrane facing the outside environment, i.e. the side that can be viewed by a subject or user.

The non-transparent membrane used in the present invention may be made by coating at least one side of a polymeric film with an ink that makes the film not transparent. Alternatively, the non-transparent membrane may be manufactured with a polymer that is inherently not transparent. Another alternative includes mixing a polymer with a die to produce a colored polymer, and using the produced polymer to manufacture a non-transparent membrane for use in the present invention.

FIG. 1, which is a cross sectional view of a light transmissive membrane 100 of the present invention, illustrates, starting from the B side, that the membrane 100 includes a top finish layer or top coat 102, a polymeric film or skin 104, such as a PVC film, a foam or intermass 106, such as a PVC foam, an adhesive layer 108 and a fabric 110. Each layer, including the ink covering the polymeric film 104, as well as the combination of all the layers of the membrane of the present invention (i.e. the whole construction of the membrane), must be light translucent. The foam layer 106 is a foam that allows light through. In the particular example of Table 1, a PVC foam was used, having a fine bubble dispersion for optimal light transparency. This construction having a light translucent foam is new and non-obvious.

The polymeric film 104 includes a side facing the B side of the membrane and a side facing the B side of the membrane. The polymeric film 104 may be covered on one or both sides with an ink. The ink may provide uniform original equipment manufacturer (OEM) required colour appearance. The ink also serves to control the amount of light transmission. As such, the polymeric film may be covered with an ink layer on the B side, or with an ink layer on the A side, or with a first ink layer on the B side and a second ink layer on the A side.

Table 1 provides details of a membrane according to one embodiment of the present invention designed for automotive interior surfaces. Tables 2 and 3 describe the physical and performance properties of the membrane of Table 1.

The membrane of the present invention is neither transparent nor semitransparent. This means that an individual looking at the surface covered by the membrane, will only be able to see the B side of the membrane, and not the surface being covered, nor any object or device placed or disposed between the surface and the A side of the membrane.

The membrane is also light transmissive. The non-transparent membrane has the property of allowing light emanating from a light source to be transmitted from the A side to the B side. This means that if a source of light is covered by the membrane, an individual looking at the B side will not be able to see the light source, but the individual will be able to see light emanating from the light source.

The light source may be activated by a suitable input means for controlling activation of the light source. The input means may be disposed on the surface being covered by the light transmissive membrane with an opaque color coating, such that the input means is hidden from view from the B side of the membrane. The input means may be a pressure or touch sensor switch or a capacitive sensor.

The light transmissive, non-transparent membrane may have a capacitive sensor located under it, on the A side and use a light source to illuminate upon the detection of capacitance. The light source would activate upon touching the B side of the light transmissive opaque membrane.

The light transmissive, non-transparent membrane may be made of any material that is opaque and light transmissive. Non limiting examples includes membranes made of Polyethylene terephthalate (PET), Thermoplastic Olefin (TPO), Polyvinyl Chloride (PVC), Polyurethane (PUR and PU) and/or Thermoplastic polyurethane (TPU).

The thickness of the membrane may range with the proviso, however, that the membrane remains non-transparent to a viewer and light transmissive. As such, if the membrane is too thin and it may become possible to see objects covered by the membrane (i.e. the membrane may no longer be not transparent), and if the membrane is too thick, light may not be able to pass from the A side to the B side of the membrane (i.e. the membrane may not be light transmissive).

The membrane may be colored, may include patterns or textures or a combination of colors, patterns and/or textures. As such, the light transmissive non-transparent membrane may be used to decorate the surface of a product while hiding functional elements of the product.

Uses

The light transmissive non-transparent membrane of the present invention may be used to convey information, be part of a user interface to control a device, or provide decorative or functional lighting.

The light transmissive, non-transparent membrane can be used on the surface of a consumer product such as automobile interiors, or consumer electronics and appliances, or in pool liners, pool steps, roofing and decking to provide, for example, branding, task lighting, ambient lighting, functional touch surfaces, driver information such as speed, telltales such as check engine lights, turn signals, low fuel warnings and any other driver information, info/entertainment information such a radio stations, climate controls, or other transient information such as state of charge, time to destination, and so forth, secret-until-lit lighting for pools, roofing materials, and decking materials.

For example, with the present invention an interior car door does not need to have a separate window switch. An area of the door panel itself can be the switch.

For a pool, the steps or walls could be secret-until-lit, employing a light sensor that measured ambient light and automatically illuminate certain areas of the pool. Roofing materials could be secret-until-lit to provide signage to be viewed from other buildings or from the air.

### Examples

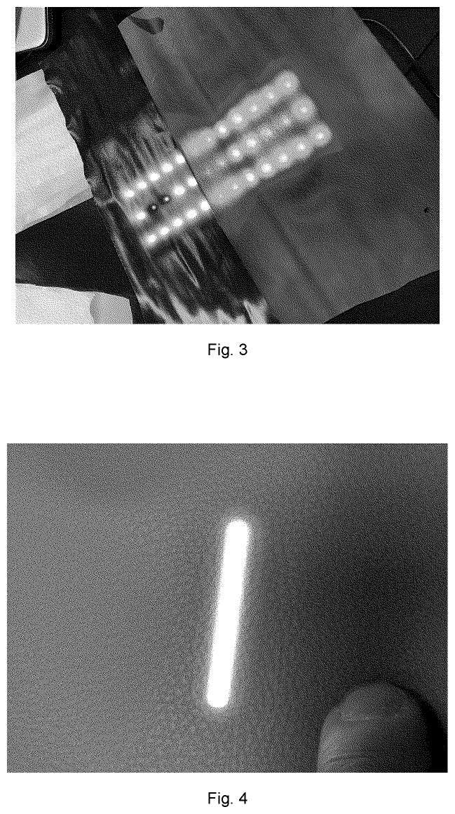

FIG. 2 illustrates a light transmissive, non-transparent membrane resting over a light source. As it can be observed, the membrane of FIG. 2 completely hides the light source until lit, as demonstrated in FIG. 3.

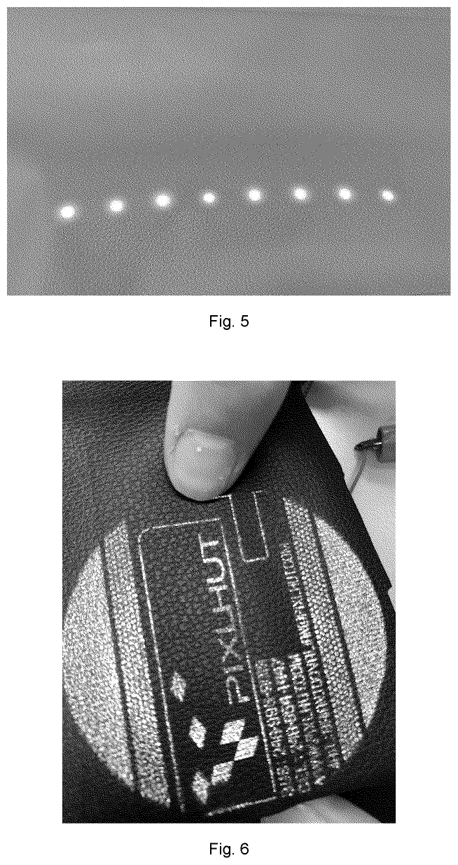

FIGS. 4 and 5 illustrate the test of light passing through a light transmissive non-transparent material.

FIG. 6 illustrates an example of a signage. A laser cut business card was placed between a light source and the membrane. As illustrated in FIG. 6, the information of the business card can be clearly seen on the side of the membrane facing the outside environment.

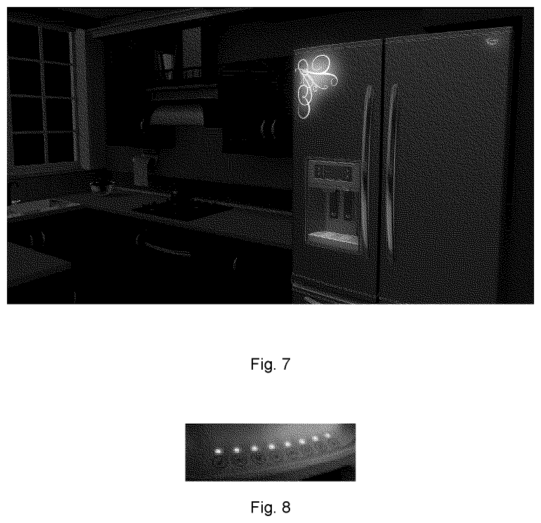

FIG. 7 illustrates an appliance (in this particular example a fridge) having its surface covered by the membrane of the present invention and revealing a design lit by a light source behind the membrane of the present invention. FIG. 8 illustrates the interior surface of a vehicle covered with a membrane of the present invention and revealing functions lit by a light source behind the membrane of the present invention.

Advantages

According to the present invention by a light transmissive opaque membrane can be used on panels, surfaces or products to provide a decorative look while hiding, or keeping secret functional elements, lighting, processors, capacitors, and so forth that can be placed on the panels, surfaces or products being covered.

With the present invention, a product with hidden capacitive or resistive switch or sensor will allow consumers to turn on/off a light on the product without detracting from the overall appearance of the product.

The nature of the light transmissive film also provides the added benefit of being a light source for either task lighting or ambient lighting.

Through the embodiments that are illustrated and described, the currently contemplated best mode of making and using the invention is described.

Without further elaboration, it is believed that one of ordinary skill in the art can, based on the description presented herein, utilize the present invention to the full extent. All publications cited are incorporated by reference.

TABLE 1

| Construction of | | | Key Specifics or |
|---|---|---|---|
| Material | Description | Key Properties | Quantities |
| Top Coat | Multiple applications | Abrasion resistance, | Number of |
| 102 | of Crosslinked PU | chemical resistance, | applications, |
| | coating | flexibility, gloss, | Crosslinker |
| | | haptics | Percentage, |
| | | | Rotogravure patterns, |
| | | | Application amount |
| First Ink Layer | Multiple applications | Provides uniform | Number of |
| | of PVC based ink | OEM required colour | applications, |
| | | appearance and also | Rotogravure patterns, |
| | | controls the amount of | Ink percentage, |
| | | light transmission | pigments used, |
| | | | Application amount, |
| | | | Solvents used |
| PVC Skin 104 | Transparent PVC | Formulated for | Thickness range, |
| | layer | optimal light | percentage, minimum |
| | | transparency and | transparency, Type of |
| | | colourlessness | plasticizer |
| Second Ink | Multiple applications | Provides uniform | Number of |
| Layer | of PVC based ink | OEM required colour | applications, |
| | | appearance and also | Rotogravure patterns, |
| | | controls the amount of | Ink percentage, |
| | | light transmission | pigments used, |
| | | | Application amount, |
| | | | Solvents used |
| Intermass | Foamed PVC layer | Fine bubble | Foam density, |
| 106 | | dispersion for optimal | thickness/weight |
| | | light transparency | |
| Adhesive | PVC adhesive layer | Adheres PET fabric to | Thickness/weight, |
| 108 | | PVC Intermass with | minimum adhesion |
| | | minimal colour and | |
| | | opacity | |
| Fabric | PET knit fabric | Fine knit structure | Weight, minimum |
| 110 | | with low denier thread | wales/courses, thread |
| | | to minimize pattern | denier, low yarn filler |
| | | read through when | content |
| | | illuminated and | |
| | | overall low opacity | |
| Overall | Back illuminated | OEM required | Light transparency |
| | OEM coverstock for | appearance, haptics | level by colour |
| | cut and sew | and performance, | |
| | applications | capacitive touch | |

TABLE 2
Physical Properties of Membrane

| Properties | Results | Test Method |
|---|---|---|
| Weight | 700-850 g/m2 | ISO 2420 |
| Gauge | 1-1.3 mm | ISO 2589 |
| Light transmittance | 10-50% | ASTM E1348 |

TABLE 3
Performance Properties of Membrane

| Properties | Results | Test Method |
|---|---|---|
| Break Strength | ≥200 N (MD & TD) | ASTM D2208 |
| Tear Resistance | ≥20 N (MD & TD) | ISO 13937-2 |
| Stretch & Set | **Stretch: 50-110% (MD), 100-120% (TD) | SAE J855 |
| | Set: 6-12% (MD), 4-16% (TD) | |
| Bond Strength | ≥18 N/5 cm (MD & TD) | ISO 2411 |
| Abrasion | No gloss or color change, | ASTM D3884 |
| | No loss of coating | |
| Scuff and Mar | No marring or scuffing present | FLTM BN 108-13, |
| | | SAE J365 |
| Flexibility | **75-90 mm (MD), 70-80 mm (TD) | ISO 14087 |
| Chemical Resistance | Soiling Agents: (Ratings ≥8) | FLTM ON 112-08, |
| | Cleaning Agents: (Ratings ≥4 Grey Scale) | SAE J861 |
| Fogging (Gravimetric) | <1.5 mg | SAE J1756 |
| Accelerated | No cracking, chalking, tackiness, loss of grain, | ISO 105-B06 |
| Weathering | wrinkling, blistering, or other undesirable | (Condition 5) |
| Resistance | effects (Ratings ≤4 Grey Scale) | |

**Tailorable to specific requirements.

What is claimed is:

1. A non-transparent light transmissive opaque membrane for covering the surface of a product, the membrane comprising:
(a) a polyethylene terephthalate (PET) knit fabric layer for covering the surface of the product;
(b) a foamed polyvinyl chloride (PVC) layer having a side attached to the PET knit fabric layer with a PVC adhesive;
(c) a top crosslinked polyurethane layer; and
(d) a transparent PVC layer between the top layer and the foamed layer, the transparent PVC layer having at least one side covered with a PVC based ink.

2. A product comprising:
(a) surface, the surface being covered with a non-transparent light transmissive opaque membrane, the non-transparent light transmissive opaque membrane having an A side facing the surface, and a B exposed side,
(b) a light source and an input means for controlling the light source, the light source and the input means being disposed between the surface and the A side of the membrane, said input means being capable of being operated by touch on the B side of the non-transparent light transmissive opaque membrane to turn the light source on and off,
wherein said non-transparent light transmissive opaque membrane is configured to transmit light emitted from the light source from the A side to the B side such that the light can be viewed from the B exposed side.

3. The product of claim 2, wherein the non-transparent light transmissive opaque membrane is the membrane of claim 1.

4. The product of claim 2, wherein the product is a consumer product.

5. The product of claim 2, wherein the product is an appliance, a door, a wall, a deck, a roof, a floor, a surface of an automobile, or a hand-held device.

6. The product of claim 2, wherein the product is a swimming pool and the non-transparent light transmissive opaque membrane is the pool liner.

7. The product of claim 2, wherein the input means is a pressure or touch sensor switch or a capacitive sensor.

8. The product of claim 2, wherein the non-transparent light transmissive opaque membrane is made of a polymer selected from thermoplastic olefin (TPO), polyvinyl chloride (PVC), polyurethane (PU), or thermoplastic polyurethane (TPU).

9. A surface coated with a non-transparent light transmissive membrane, the non-transparent light transmissive membrane having an A side facing the surface, and a B side facing an open environment, a light source and an input means for controlling the light source being disposed between the surface and the A side of the membrane, said input means capable of being operated by touch on the B side of the non-transparent light transmissive membrane to turn the light source on and off, and said non-transparent light transmissive membrane being capable of transmitting light emitted from the light source from the A side to the B side such that the light can be viewed from the open environment.

10. The surface of claim 9, wherein the non-transparent light transmissive membrane is the non-transparent light transmissive membrane of claim 1.

11. The coated surface of claim 9, wherein the surface is part of a consumer product.

12. The coated surface of claim 9, wherein the surface is part of an appliance, a door, a wall, a deck, a roof, a floor, a surface of an automobile, a hand-held device.

13. The coated surface of claim 9, wherein the surface is the walls of a swimming pool and the non-transparent light transmissive membrane is the pool liner.

14. The coated surface of claim 9, wherein the input means is a pressure or touch sensor switch or a capacitive sensor.

15. The coated surface of claim 9, wherein the non-transparent light transmissive membrane is made of a polymer selected from thermoplastic olefin (TPO), polyvinyl chloride (PVC), polyurethane (PU), or thermoplastic polyurethane (TPU).
